(19) United States
(12) Patent Application Publication
(10) Pub. No.: US 2024/0376248 A1
(43) Pub. Date: Nov. 14, 2024

(54) RENEWABLE LOW VISCOSITY ALGAE-BASED POLYESTER-POLYOLS FOR BIODEGRADABLE THERMOPLASTIC POLYURETHANES

(71) Applicants: The Regents of the University of California, Oakland, CA (US); Algenesis Corporation, Cardiff, CA (US)

(72) Inventors: Michael David Burkart, La Jolla, CA (US); Thien An Phung Hai, La Jolla, CA (US); Bhausaheb Shivaji Rajput, La Jolla, CA (US); Nitin Neelakantan, Cardiff, CA (US)

(21) Appl. No.: 18/781,830

(22) Filed: Jul. 23, 2024

Related U.S. Application Data
(63) Continuation of application No. PCT/US2023/011467, filed on Jan. 24, 2023.
(60) Provisional application No. 63/302,797, filed on Jan. 25, 2022.

(51) Int. Cl. C08G 18/42; C08G 18/32; C09D 7/80; C09D 175/06

(52) U.S. Cl. CPC C08G 18/4236; C08G 18/3206; C09D 7/80; C09D 175/06; C08G 2150/00; C08G 2230/00

(57) ABSTRACT

Disclosed herein are polyester-polyols comprising subunits from succinic acid, a linear aliphatic dicarboxylic acid with at least 9 carbons, and a C₂-C₆ diol, wherein the polyester-polyol has a viscosity of less than 2400 cP at 55° C., and thermoplastic polyurethanes (TPUs) prepared from the same, as well as methods of preparation of the polyester-polyols and TPUs, methods of their use, and products containing the same.

### CROSS-REFERENCE TO RELATED APPLICATIONS

This application is a bypass continuation of International Application No. PCT/US2023/011467, filed on Jan. 24, 2023, which claims priority to U.S. Provisional Application No. 63/302,797, filed on Jan. 25, 2022, the contents of each of which are incorporated by reference herein in their entireties.

### STATEMENT OF GOVERNMENT SUPPORT

This invention was made with government support under Grant No. DE-EE008246 awarded by the United States Department of Energy (DoE). The government has certain rights in this invention.

### BACKGROUND

Many industries today remain dependent upon feedstock chemicals sourced from petroleum.¹ Renewable resources, including plant and algae sourced biomass, offer a promising alternative to petroleum for chemical production, but challenges associated with availability, purity, and cost have hindered their development and puts them at a disadvantage for many applications.¹ The objective of the present technology is the development of a new class of renewable and biodegradable polymers, with the goal of developing sustainable products from environmentally-friendly raw materials.^{2,3,4,5,6} This objective is inspired by minimization of greenhouse gases from fossil sources and elimination of plastic waste from the environment and represents a growing interest to consumers and, by extension, manufacturers.^{7 8,9,10,11,12,13,14} Comparison to other renewable resources, algae biomass has experienced growing interest as a future source for producing sustainable materials due to flexible habitat preferences, fast growth rate, and substantial yield. Polyurethanes (PUs) are a widely-used polymer where renewable feedstocks have already found measurable but limited adoption.¹⁵ The market for PUs is growing continuously due to its versatility in product applications,¹⁶ which presents the opportunity to replace large quantities of petroleum-derived chemicals with renewable PUs that may also be biodegradable.⁴

PUs are prepared from two major components: polyols and diisocyanates.¹⁶ Depending on end use, the gross mechanical properties of PU polymers can be tailored by changing these components, and formulations can be fine-tuned for specific application requirements. Thermoplastic polyurethanes (TPUs) are segmented elastomers derived from polyols that function as soft segments, and hard segments are made up from diisocyanates and small molecule chain extenders.⁴ Nowadays, TPUs attract significant attention because of their outstanding properties, including mechanical strength, abrasion resistance, transparency, and elasticity. Polyester-polyols have been used in PU elastomers, sealants, adhesives and coatings,⁴ and they are responsible for many valuable TPU properties, including solvent, oil, and acid resistance.¹⁷ However, polyester-polyol based PUs are less resistant to hydrolysis when compared to polyethers. However, this propensity for hydrolysis also makes them substantially more favorable for end-of-life biodegradation.^{18,19,20}

TPUs properties depend on polyol identity and can vary from soft elastomers to hard plastics. Poly(propylene succinate) PPS is one well-known, bio-based polyester-polyol used for coating and elastomeric TPUs with low melting points.^{18, 21, 22} Higher melting point poly(ethylene succinate) PES and poly(butylene succinate) PBS, also bio-based, have more limited practical applications.¹⁸ Although promising, these do not offer the diversity of material properties needed to realistically replace petroleum-sourced TPUs, and the technology disclosed herein is the result of a search for new polyol varieties. Beyond renewability and biodegradability, the inventors have prioritized low viscosity polyols as drop-in replacements for existing manufacturing equipment. Low viscosity polyols allow reduction in processing temperature, faster processing time, lower manufacturing costs, the ability to use low-boiling isocyanates, and solvent-free coating applications.

### SUMMARY

Described herein is the preparation of bio-based, low viscosity, and algae-based polyester-polyols and characterization of their properties, usefulness in high algae-content TPU preparation, and material performance and biodegradation of the TPU polymers.

In one aspect, provided herein is a method to prepare a biodegradable thermoplastic polyurethane (TPU), the method comprising:
contacting succinic acid, a linear aliphatic dicarboxylic acid with at least 9 carbons, and a C₂-C₆ diol in a first polymerization reaction to obtain a linear aliphatic polyester-polyol; and
contacting the linear aliphatic polyester-polyol with a chain extender and a diisocyanate in a second polymerization reaction to obtain the TPU;
wherein the linear aliphatic polyester-polyol has a viscosity of less than 2400 cP at 55° C.

In some embodiments, the linear aliphatic polyester-polyol has a viscosity of about 887 cP to about 2130 cP at 55° C. In some embodiments, the linear aliphatic dicarboxylic acid comprises azelaic acid, sebacic acid, undecanedioic acid, dodecanedioic acid, tridecanedioic acid, or a combination of two or more thereof. In some embodiments, the linear aliphatic dicarboxylic acid is derived from algae. In some embodiments, succinic acid and the linear aliphatic dicarboxylic acid are present in the first polymerization reaction in a molar ratio of greater than 1:1. In some embodiments, succinic acid and the linear aliphatic dicarboxylic acid are present in the first polymerization reaction in a molar ratio of at least 3:1. In some embodiments, the C₂-C₆ diol comprises 1,3-propanediol; 1,4-butanediol; 1,5-pentanediol; 1,6-hexanediol; or a combination of two or more thereof. In some embodiments, the first polymerization reaction is initially conducted at a temperature of about 150° C. to about 160° C. In some embodiments, the temperature for the first polymerization reaction is subsequently raised to about 180° C. for at least 2 days. In some embodiments, the linear aliphatic polyester-polyol is a liquid at 25° C. In some embodiments, the linear aliphatic polyester-polyol has a molecular weight (by OH number value or hydroxyl number value) of about 1800 to about 2000. In some embodiments, the chain extender comprises 1,3-propanediol; 1,4-butanediol; 1,5-pentanediol; 1,6-hexanediol; or a combination of two or more thereof. In some embodiments, the diisocyanate comprises 1,6-hexamethylene diisocyanate, 1,7-heptamethylene diisocyanate, or a combination thereof. In some embodiments, the diisocyanate is derived from algae. In some embodiments, the polyester-polyol, the chain extender, and the diisocyanate are present in the TPU in a molar ratio of 1:1:2.1 to 1:1:2.2 (polyester-polyol:chain extender:diisocyanate). In some embodiments, the second polymerization reaction is conducted at about 75° C. In some embodiments, the second polymerization reaction further comprises a catalyst. In some embodiments, the catalyst is dibutyltin dilaurate. In some embodiments, the TPU has a number average molecular weight (Mₙ) of about 133,000 to about 312,000 g/mol. In some embodiments, the TPU has about 17% to about 76% carbon content from algae. In some embodiments, the TPU demonstrates at least about 30% decrease in number average molecular weight (Mₙ) or weight average molecular weight (M_{w}) after incubation under composting conditions for 9 weeks. In some embodiments, the composting conditions comprise contact with one or more compost microorganisms at a temperature of about 45° C. with about 75% to 85% relative humidity. In some embodiments, the TPU achieves at least 70% biodegradation as measured by respirometry analysis after ASTM D5338 testing.

In another aspect, provided herein is a linear aliphatic polyester-polyol comprising subunits from succinic acid, a linear aliphatic dicarboxylic acid with at least 9 carbons, and a C₂-C₆ diol, wherein the polyester-polyol has a viscosity of less than 2400 cP at 55° C. In some embodiments, the polyester-polyol is a liquid at 25° C. In some embodiments, the polyester-polyol has a viscosity of about 887 cP to about 2130 cP at 55° C. In some embodiments, the linear aliphatic dicarboxylic acid comprises azelaic acid, sebacic acid, undecanedioic acid, dodecanedioic acid, tridecanedioic acid, or a combination of two or more thereof. In some embodiments, the linear aliphatic dicarboxylic acid with at least 9 carbons is derived from algae. In some embodiments, more than 50% of dicarboxylic acid subunits are from succinic acid. In some embodiments, at least 75% of dicarboxylic acid subunits are from succinic acid. In some embodiments, the C₂-C₆ diol comprises 1,3-propanediol; 1,4-butanediol; 1,5-pentanediol; 1,6-hexanediol; or a combination of two or more thereof. In some embodiments, the polyester-polyol has a molecular weight (by OH number value or hydroxyl number value) of about 1800 to about 2000.

In another aspect, provided herein is a biodegradable thermoplastic polyurethane (TPU) comprising subunits from a diisocyanate, a chain extender, and a linear aliphatic polyester-polyol, wherein the polyester-polyol has a viscosity of less than 2400 cP at 55° C.; and wherein the TPU demonstrates at least about 30% decrease in number average molecular weight (Mₙ) or weight average molecular weight (M_{w}) after incubation under composting conditions for 9 weeks. In some embodiments, the composting conditions comprise contact with one or more compost microorganisms at a temperature of about 45° C. with about 75% to 85% relative humidity. In some embodiments, the diisocyanate comprises 1,6-hexamethylene diisocyanate, 1,7-heptamethylene diisocyanate, or a combination thereof. In some embodiments, the diisocyanate is derived from algae. In some embodiments, the chain extender comprises 1,3-propanediol; 1,4-butanediol; 1,5-pentanediol; 1,6-hexanediol; or a combination of two or more thereof. In some embodiments, the polyester-polyol comprises subunits from succinic acid, a linear aliphatic dicarboxylic acid with at least 9 carbons, and a C₂-C₆ diol. In some embodiments, the linear aliphatic dicarboxylic acid comprises azelaic acid, sebacic acid, undecanedioic acid, dodecanedioic acid, tridecanedioic acid, or a combination of two or more thereof. In some embodiments, the linear aliphatic dicarboxylic acid is derived from algae. In some embodiments, more than 50% of dicarboxylic acid subunits in the polyester-polyol are from succinic acid. In some embodiments, at least 75% of dicarboxylic acid subunits in the polyester-polyol are from succinic acid. In some embodiments, the C₂-C₆ diol comprises 1,3-propanediol; 1,4-butanediol; 1,5-pentanediol; 1,6-hexanediol; or a combination of two or more thereof. In some embodiments, the polyester-polyol, the chain extender, and the diisocyanate are present in the TPU in a molar ratio of 1:1:2.1 to 1:1:2.2 for polyester-polyol:chain extender:diisocyanate. In some embodiments, the polyester-polyol is a liquid at 25° C. In some embodiments, the polyester-polyol has a viscosity of about 887 cP to about 2130 cP at 55° C. In some embodiments, the TPU has a number average molecular weight (Mₙ) of about 133,000 to about 312,000 g/mol. In some embodiments, the TPU has about 17% to about 76% carbon content from algae. In some embodiments, the TPU achieves at least 70% biodegradation as measured by respirometry analysis after ASTM D5338 testing.

In another aspect, provided herein is a process to prepare paint, the process comprising:
preparing a polyester polyol of 1000 to 3000 g/mol molecular weight from succinic acid, a linear aliphatic dicarboxylic acid with at least 9 carbons, and a C₂-C₆ diol; wherein the linear aliphatic dicarboxylic acid is derived from algae;
preparing a TPU from (a) the polyester polyol; (b) a chain extender; (c) a tin- or titanium-based catalyst; and (d) an aromatic or aliphatic diisocyanate; wherein the TPU comprises 65 wt. % to 90 wt. % polyester polyol, 2 wt. % to 6 wt. % chain extender; and 10% to 30% hard segment due to the diisocyanate; and
solubilizing the TPU in a solvent to provide a TPU solution; and
mixing the TPU solution with a pigment to produce the paint.

In some embodiments, the TPU was prepared from a polyester polyol of 1500 g/mol molecular weight, propanediol at 6 parts per 100 parts of polyol, a tin- or titanium-based catalyst, and 1,6-hexamethylene diisocyanate (6HDI) or 1,7-heptamethylene diisocyanate (7HDI) with about 23% hard segment. In some embodiments, the paint comprises 2 wt. % to 40 wt. % TPU, 0 wt. % to 10 wt. % pigment, 60 wt. % to 98 wt. % N,N′-dimethylformamide, and 0 wt. % to 20 wt. % methyl ethyl ketone. In some embodiments, the paint comprises about 10 wt. % TPU, 2 wt. % pigment, and 88 wt. % N,N′-dimethylformamide.

### BRIEF DESCRIPTION OF THE DRAWINGS

FIG. 1 depicts viscosity comparison between different polyester-polyols. SuAAzAPDO: polyester-polyol from succinic acid, azelaic acid, and 1,3-propanediol; SuAPDO: polyester-polyol from succinic acid and 1,3-propanediol; AzAPDO: polyester-polyol from azelaic acid and 1,3-propanediol; SuASbPDO: polyester-polyol from succinic acid, sebacid acid, and 1,3-propanediol.

FIG. 2 depicts data visualization for algae-content and bio-content in certain embodiments of the TPUs of the present technology.

FIG. 3 depicts storage modulus of TPU1 with respect to temperature.

FIG. 4 depicts loss modulus of TPU1 with respect to temperature.

FIG. 5 depicts Tan delta of TPU1 with respect to temperature.

FIG. 6 depicts scanning electron micrographs of TPU1 and TPU4 after nine weeks of biodegradation in compost. Control samples (left) are compared to compost samples (right) for morphological changes. Micrographs were taken at approximately 200× magnification.

FIG. 7 depicts biodegradation percentage of cellulose, positive control, and TPU1 sample based on carbon dioxide production following ASTM D5338 respirometry analysis. Percentages are determined through considering background compost carbon dioxide production and carbon content of samples.

FIG. 8 depicts FTIR spectrum for biodegraded TPU1 and control sample for comparison.

FIG. 9 depicts FTIR spectrum for biodegraded TPU4 and control sample for comparison.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

### Low Viscosity Polyester-Polyols

In one aspect, disclosed herein are low viscosity polyester-polyols. Unless otherwise indicated, as used herein “low viscosity” refers to a viscosity of less than 2400 cP at 55° C. This includes a viscosity of about 800 cP to less than 2400 cP, about 800 cP to about 2350 cP, about 900 cP to about 2350 cP, about 1000 cP to about 2350 cP, about 800 cP to about 2300 cP, about 800 cP to about 2200 cP, about 1000 cP to about 2300 cP, about 1000 cP to about 2200 cP, and about 1100 cP to about 2300 cP. In some embodiments, the viscosity is about 887 cP to about 2130 cP. In some embodiments, the viscosity is about 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, 2000, 2050, 2100, 2150, 2200, 2250, 2300, 2350 cP, or a value therebetween.

In another aspect, disclosed herein is a linear aliphatic polyester-polyol comprising, consisting essentially of, or consisting of subunits from succinic acid, a linear aliphatic dicarboxylic acid with at least 9 carbons, and a C₂-C₆ diol, wherein the linear aliphatic polyester-polyol has a viscosity of less than 2400 cP at 55° C.

In another aspect, disclosed herein is a linear aliphatic polyester-polyol comprising, consisting essentially of, or consisting of subunits from one or more diacids, such as succinic acid or a linear aliphatic dicarboxylic acid with at least 9 carbons, and two or more C₂-C₆ diols, wherein the linear aliphatic polyester-polyol has a viscosity of less than 2400 cP at 55° C.

In some embodiments, the linear aliphatic polyester-polyol is a liquid, semisolid, or solid at 25° C. In some embodiments, the linear aliphatic polyester-polyol is a liquid at 25° C.

The linear aliphatic dicarboxylic acid with at least 9 carbons may have 9, 10, 11, 12, 13, 14, or 15 carbons. In some embodiments, the linear aliphatic dicarboxylic acid comprises, consists essentially of, or consists of azelaic acid, sebacic acid, undecanedioic acid, dodecanedioic acid, tridecanedioic acid, or a combination of two or more thereof. In some embodiments, the linear aliphatic dicarboxylic acid comprises, consists essentially of, or consists of azelaic acid, sebacic acid, or a combination thereof.

In some embodiments, the linear aliphatic dicarboxylic acid with at least 9 carbons is derived from algae.

In some embodiments, 25-75% of dicarboxylic acid subunits are from succinic acid. This includes 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, or 75% In some embodiments, 25-50% of dicarboxylic acid subunits are from succinic acid. In some embodiments, more than 50% of dicarboxylic acid subunits are from succinic acid. In some embodiments, 50-75% of dicarboxylic acid subunits are from succinic acid. In some embodiments, at least 75% of dicarboxylic acid subunits are from succinic acid.

In some embodiments, the C₂-C₆ diol comprises, consists essentially of, or consists of 1,3-propanediol; 1,4-butanediol; 1,5-pentanediol; 1,6-hexanediol; or a combination of two or more thereof. In some embodiments, the C₂-C₆ diol comprises, consists essentially of, or consists of 1,3-propanediol. In some embodiments, the C₂-C₆ diol comprises, consists essentially of, or consists of 1,4-butanediol. In some embodiments, the C₂-C₆ diol comprises, consists essentially of, or consists of 1,5-pentanediol. In some embodiments, the C₂-C₆ diol comprises, consists essentially of, or consists of 1,6-hexanediol.

In some embodiments, the linear aliphatic polyester-polyol has a molecular weight (by OH number value or hydroxyl number value of polyols) of about 1800 to about 2000. This includes a molecular weight (by OH number value or hydroxyl number value of polyols) of about 1800, 1825, 1850, 1875, 1900, 1925, 1950, 1975, 2000, and values therebetween.

### Thermoplastic Polyurethanes (TPUs)

In another aspect, disclosed herein are biodegradable thermoplastic polyurethanes (TPUs) comprising, consisting essentially of, or consisting of subunits from a diisocyanate, a chain extender, and a linear aliphatic polyester-polyol as described herein, wherein the polyester-polyol has a viscosity of less than 2400 cP at 55° C.; and wherein the TPU demonstrates at least about 30% decrease in number average molecular weight (Mₙ) or weight average molecular weight (M_{w}) after incubation under composting conditions for 9 weeks.

In some embodiments, the composting conditions comprise, consist essentially of, or consist of contact with one or more compost microorganisms at a temperature of about 45° C. with about 75% to 85% relative humidity.

In some embodiments, the diisocyanate comprises, consists essentially of, or consists of 1,6-hexamethylene diisocyanate, 1,7-heptamethylene diisocyanate, or a combination thereof. In some embodiments, the diisocyanate comprises, consists essentially of, or consists of 1,6-hexamethylene diisocyanate. In some embodiments, the diisocyanate comprises, consists essentially of, or consists of 1,7-heptamethylene diisocyanate. In some embodiments, the diisocyanate is derived from algae.

In some embodiments, the chain extender comprises, consists essentially of, or consists of 1,3-propanediol; 1,4-butanediol; 1,5-pentanediol; 1,6-hexanediol; or a combination of two or more thereof. In some embodiments, the chain extender comprises, consists essentially of, or consists of 1,3-propanediol. In some embodiments, the chain extender comprises, consists essentially of, or consists of 1,4-butanediol. In some embodiments, the chain extender comprises, consists essentially of, or consists of 1,5-pentanediol. In some embodiments, the chain extender comprises, consists essentially of, or consists of 1,6-hexanediol.

In some embodiments, the polyester-polyol, the chain extender, and the diisocyanate are present in the TPU in a molar ratio of 1:1:2.1 to 1:1:2.2 for polyester-polyol:chain extender:diisocyanate.

In some embodiments, the TPU has a number average molecular weight (Mₙ) of about 133,000 g/mol to about 312,000 g/mol. This includes a Mₙ of about 133,000; 135,000; 140,000; 145,000; 150,000; 155,000; 160,000; 165,000; 170,000; 175,000; 180,000; 185,000; 190,000; 195,000; 200,000; 205,000; 210,000; 215,000; 220,000; 225,000; 230,000; 235,000; 240,000; 245,000; 250,000; 255,000; 260,000; 265,000; 270,000; 275,000; 280,000; 285,000; 290,000; 295,000; 300,000; 305,000; 310,000; 312,000 g/mol; and values therebetween.

In some embodiments, the TPU has about 17% to about 76% carbon content from algae. This includes about 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, or 75% carbon content from algae.

In some embodiments, the TPU achieves at least 70% biodegradation as measured by respirometry analysis after ASTM D5338 testing. In some embodiments, the TPU achieves about 70% to about 80% biodegradation as measured by respirometry analysis after ASTM D5338 testing. In some embodiments, the TPU achieves about 75% biodegradation as measured by respirometry analysis after ASTM D5338 testing.

### Methods to Prepare TPUs

In another aspect, disclosed herein is a method to prepare a biodegradable thermoplastic polyurethane (TPU), the method comprising, consisting essentially of, or consisting of:
contacting succinic acid, a linear aliphatic dicarboxylic acid with at least 9 carbons, and a C₂-C₆ diol in a first polymerization reaction to obtain a linear aliphatic polyester-polyol as described herein; and
contacting the linear aliphatic polyester-polyol with a chain extender and a diisocyanate in a second polymerization reaction to obtain the TPU;
wherein the linear aliphatic polyester-polyol has a viscosity of less than 2400 cP at 55° C.

In some embodiments, the succinic acid and the linear aliphatic dicarboxylic acid are present in the first polymerization reaction in a molar ratio of greater than 1:1. This includes 1.1:1, 1.2:1, 1.3:1, 1.4:1, 1.5:1, 1.6:1, 1.7:1, 1.8:1, 1.9:1, 2:1, 2.1:1, 2.2:1, 2.3:1, 2.4:1, 2.5:1, 2.6:1, 2.7:1, 2.8:1, 2.9:1, 3:1, 3.1:1, 3.2:1, 3.3:1, 3.4:1, 3.5:1, and values therebetween. In some embodiments, the succinic acid and the linear aliphatic dicarboxylic acid are present in the first polymerization reaction in a molar ratio of at least 3:1.

In some embodiments, the first polymerization reaction is initially conducted at a temperature of about 150° C. to about 160° C. This includes an initial temperature of about 150, 151, 152, 153, 154, 155, 156, 157, 158, 159, 160° C., or any value therebetween.

In some embodiments, the temperature for the first polymerization reaction is subsequently raised to about 180° C. for at least 2 days. This includes 2, 3, 4, or 5 days, including any value therebetween.

In some embodiments, the second polymerization reaction is conducted at about 75° C.

In some embodiments, the second polymerization reaction further comprises a catalyst. In some embodiments, the catalyst is dibutyltin dilaurate.

### Products and Processes to Prepare the Same

In another aspect, disclosed herein is a product comprising a TPU described herein. In some embodiments, the product is paint. In some embodiments, the paint comprises a TPU, a solvent, and a pigment.

In another aspect, disclosed herein is a process to prepare paint, the process comprising:
preparing a polyester polyol of 1000 to 3000 g/mol molecular weight from succinic acid, a linear aliphatic dicarboxylic acid with at least 9 carbons, and a C₂-C₆ diol; wherein the linear aliphatic dicarboxylic acid is derived from algae;
preparing a TPU from (a) the polyester polyol; (b) a chain extender; (c) a tin- or titanium-based catalyst; and (d) an aromatic or aliphatic diisocyanate; wherein the TPU comprises 65 wt. % to 90 wt. % polyester polyol, 2 wt. % to 6 wt. % chain extender; and 10% to 30% hard segment due to the diisocyanate; and
solubilizing the TPU in a solvent to provide a TPU solution; and
mixing the TPU solution with a pigment to produce the paint.

In some embodiments, the TPU was prepared from a polyester polyol of 1500 g/mol molecular weight, propanediol at 6 parts per 100 parts of polyol, a tin- or titanium-based catalyst, and 1,6-hexamethylene diisocyanate (6HDI) or 1,7-heptamethylene diisocyanate (7HDI) with about 23% hard segment.

In some embodiments, the paint comprises, consists essentially of, or consists of 2 wt. % to 40 wt. % TPU, 0 wt. % to 10 wt. % pigment, 60 wt. % to 98 wt. % N,N′-dimethylformamide, and 0 wt. % to 20 wt. % methyl ethyl ketone. In some embodiments, the paint comprises, consists essentially of, or consists of about 10 wt. % TPU, 2 wt. % pigment, and 88 wt. % N,N′-dimethylformamide.

The present invention, thus generally described, will be understood more readily by reference to the following examples, which are provided by way of illustration and are not intended to be limiting of the present invention.

### EXAMPLES

### Materials and Methods

Sebacic acid (98% purity), azelaic acid (98% purity) supplied by Acros Organics and succinic acid (99.5% purity) supplied by Fisher bioreagents (Fisher scientific) were used as received in the polyol synthesis. The 1,3-propanediol (1,3-PDO) with 98% purity and dibutyltin dilaurate catalyst (95%) were purchased from Sigma Aldrich. In preparation of TPUs, 1,6-hexamethylene diisocyanate (6HDI) with 98% purity was supplied by Alfa Aesar and used as such without purification. Hydroxyl and acid value titrations were performed according to ASTM 1899 and D664, respectively. p-Toluenesulfonyl isocyanate (96% purity) and 1.0 M tetrabutylammonium hydroxide in methanol were supplied by Sigma Aldrich. HPLC grade acetonitrile, toluene, 2-propanol, reagent grade 1-octanol, and potassium hydroxide were supplied by Fisher Chemical.

FTIR analyses were performed on a Perkin Elmer Spectrum X fitted with a ZnSe 1 mm ATR cell, 16 scans were taken at a 1.0 cm⁻¹ resolution. DMA analysis for TPU's was carried out on TA instrument with DMA oscillatory temperature ramp using a 3-point bending clamp over the temperature range of −120 to 120° C. using TA instruments. ¹H NMR and ¹³C NMR spectra were recorded on a JOEL ECA 500. UTM machine AGS-X 20KN was used to carry out tensile testing at the rate of 500 mm/min. DSC analysis was performed on TA instrument from −120° C. to 220° C. at the rate of 10° C./min under nitrogen atmosphere. Thermal gravimetric analysis (TGA) was carried out on TA instrument from 50-800° C. using temperature ramp of 10° C./min in nitrogen atmosphere. Scanning electron microscopy (SEM) analysis was performed on FEI quanta FEG 250 SEM using a 70× magnification. Gel permeation chromatography was carried out in a Malvern GPC system equipped with D4000 single-pore column and D-6000M general-purpose mixed-bed divinylbenzene column. The molecular weight and molecular weight distribution of the polymers were calculated relative to a polystyrene standard, DMF served as the polymer solvent and eluent in an equilibrated system at 40° C. Viscosity measurement was carried out at 55° C. on Brookfield Dial Viscometer with model number NDJ-SS, spindle 3 which has a diameter of 12.7 mm.

### General Procedure for Synthesis of Polyester-Polyols

A three-necked round bottom flask was equipped with a Dean-Stark apparatus, reflux condenser, and an oil bath for temperature control. Calculated amounts of diacid(s) and diol were added under the nitrogen atmosphere (see Table 1). Polymerization was initiated at 150-160° C. and subsequently the temperature was increased up to 180° C. over about an hour. In the initial 4-5 hours, rapid release of water by-product was observed, and subsequently, catalyst was added when 80% water was collected and reaction was continued until desired acid and OH number was obtained (approximately 2-3 days for the acid number to drop under 1-2 mg KOH g⁻¹). The progress of the reaction was monitored by analyzing the acid and hydroxyl numbers periodically.

TABLE 1
Formulations used in the synthesis of polyester-polyols.

| | Diacids (mole) | | | | ^{a}DBTDL |
|---|---|---|---|---|---|
| Polyester- | Succinic | Sebacic | Azelaic | Diol | Catalyst |
| Polyols | acid | acid | acid | (mole) | (mole %) |
| PPS | 1.21 | — | — | 1.32 | 0.013 |
| Poly1 | 2.0 | 0.66 | — | 2.89 | ^{b}0.005 |
| Poly2 | 0.72 | 0.72 | — | 1.60 | 0.017 |
| Poly3 | 0.33 | 0.98 | — | 1.45 | 0.018 |
| Poly4 | 2.05 | — | 0.68 | 2.99 | 0.014 |
| Poly5 | 0.74 | — | 0.74 | 1.65 | 0.016 |
| Poly6 | 0.34 | — | 1.03 | 1.52 | 0.017 |
| Poly7 | — | — | 2.11 | 2.36 | 0.018 |

^{a}DBTDL = Dibutyltin dilaurate catalyst;
^{b}Titanium isopropoxide catalyst.

### General Procedure for Synthesis of Thermoplastic Polyurethanes

Previously dried polyester-polyol, 1,3-propanediol, and catalyst were weighed into a plastic cup and heated up to 75° C., and then mixed using a speed mixer at 2000 rpm for 1 min. In another container, 1,6-hexamethylene diisocyanate (6HDI) or 1,7-heptamethylene diisocyanate (7HDI) was also heated up to 75° C. Afterwards, the heated diisocyanate was added to the polyol mixture and mixed at 2000 rpm for 2 min. An exothermic reaction was observed after mixing the diisocyanate, and complete curing was avoided in the plastic cup. Finally, the polymer mixture was poured immediately into a Teflon petri dish and cured at 75° C. for 2 days to obtain a sheet or film product. ASTM D638 dog bone shaped cutting die were used to make sample specimens.

### General Procedure for Biodegradation of Thermoplastic Polyurethanes

TPU samples were cut into approximately 1 cm×1 cm×2 mm pieces and incubated, buried in compost at 45° C. with relative humidity maintained from 75-85% throughout the course of time. Three pieces were incubated for each TPU sample for 9 weeks. TPU samples were taken out, compost debris was wiped off, and TPU samples were left to dry at room temperature overnight. Samples were then cut and weighed to 4-6 mg. Dimethylformamide (DMF) was added to each sample at a concentration of 1 mL DMF to every 5 mg of TPU sample. Samples were then run on Gel Permeation Chromatography instrument for molecular weight determination.

### Example 1. Preparation of Polyester-Polyols and their Characterization

A series of algae-based low viscosity bio-based polyester-polyols from one or more of azelaic acid, succinic acid, and sebacic acid with bio-based 1,3-propanediol were prepared according to the general procedure described above. Azelaic acid was derived from algae oil using a previously reported method.⁸ This method involved the ozonolysis of algae-extracted palmitoleic acid (C16:1) to generate polymerization-grade azelaic acid. The detailed composition of these biobased polyester-polyols is presented in Tables 1 and 2.

Initially, for viscosity comparison, bio-based poly(propylene succinate) (PPS) polyester-polyol (made from succinic acid and 1,3 propanediol) was prepared following literature procedure with slight modifications and had a viscosity of up to 2653 cP at 55° C. (see Table 3, Run 01: PPS).²³ The higher viscosity of poly(propylene succinate) polyester-polyol limits the operation of polyurethanes synthesis at much lower temperature especially while using low-boiling isocyanates. Hence, to address the issue of high viscosity, a series of bio-based polyester-polyols were synthesized with target molecular weight 2000 g mol⁻¹ via polycondensation reaction between one or more of succinic acid, azelaic acid, and sebacic acid, with 1,3-propanediol (Scheme 1). A 1-2% excess of diol relative to stoichiometry of the final product was used to compensate for evaporative losses that occurred during the reaction (confirmed by lower than expected hydroxyl number titration). Properties of the polyester-polyols are summarized in Table 3.

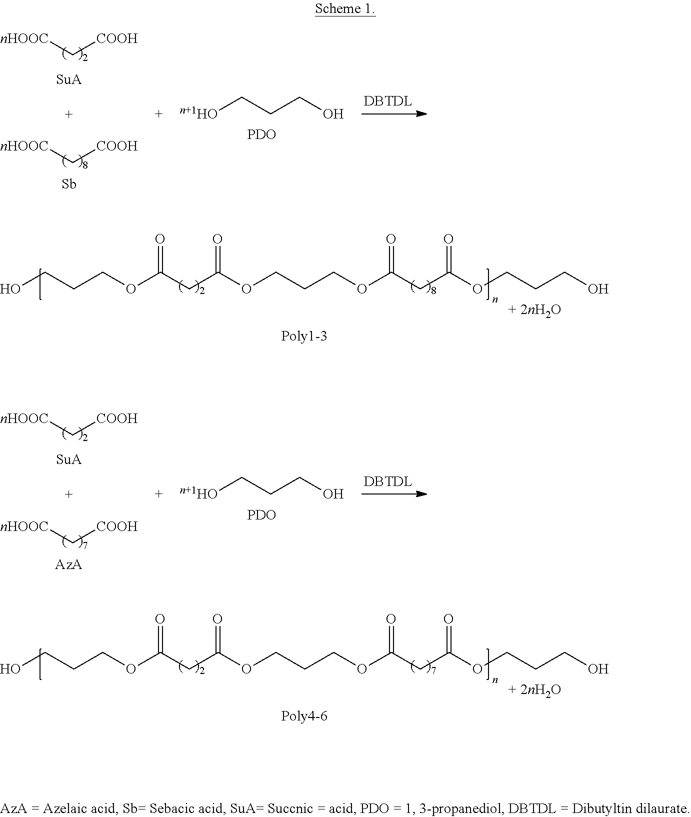

The structure of the polyester-polyols was ascertained from ¹H and ¹³C NMR. ¹H NMR of polyols Poly1-3 shows a chemical shift at around 2.56-2.59 ppm and 2.23-2.25 ppm which corresponds to the ester group attached methylene protons (originated from the succinic acid and sebacic acid backbone, respectively), whereas the signal at 4.20-4.22 ppm corresponds to the ester attached methylene group (originated from the 1,3-propanediol backbone). Furthermore, the identity of Poly1-3 polyol structures is corroborated by ¹³C NMR. The resonance at 173.78-174.25 ppm is the characteristic peak of the ester carbonyl carbon. Similarly, the structural identity of Poly4-6 polyester-polyols was also confirmed with the help of ¹H and ¹³C NMR.

Polyester-polyol/Poly1: ¹H NMR (500 MHz, Chloroform-d) δ=4.19 (s), 4.10 (s), 3.63 (s), 2.57 (s), 2.25 (s), 1.91 (s), 1.81 (s), 1.55 (s), 1.24 (s). ¹³C NMR (126 MHz, Chloroform-d) δ=173.81, 172.26, 77.47, 76.96, 61.78, 60.89, 59.02, 34.23, 31.70, 29.10, 27.91, 24.91.

Polyester-polyol/Poly2: ¹H NMR (500 MHz, Chloroform-d) δ=4.09 (s), 4.08 (s), 4.06 (s), 3.62 (s), 3.61 (s), 2.56 (s), 2.23 (s), 2.22 (s), 1.89 (s), 1.79 (s), 1.53 (s), 1.22 (s). ¹³C NMR (126 MHz, Chloroform-d) δ=173.81, 172.26, 76.99, 60.78, 58.95, 34.22, 31.78, 29.00, 27.96, 24.90.

Polyester-polyol/Poly3: ¹H NMR (500 MHz, Chloroform-d) δ=4.20 (s), 4.08 (s), 3.63 (s), 2.59 (s), 2.25 (s), 1.91 (s), 1.81 (s), 1.56 (s), 1.25 (s). ¹³C NMR (126 MHz, Chloroform-d) δ=173.84, 172.28, 77.45, 61.42, 60.89, 59.03, 34.32, 31.82, 29.12, 29.02, 28.04, 24.93.

Polyester-polyol/Poly4: 1H NMR (500 MHz, Chloroform-d) δ=4.22 (s), 4.10 (s), 3.64 (s), 2.60 (s), 2.26 (s), 2.24 (s), 1.94 (s), 1.82 (s), 1.58 (s), 1.27 (s). ¹³C NMR (126 MHz, Chloroform-d) δ=173.78, 172.28, 77.44, 76.93, 61.33, 60.82, 59.06, 34.22, 31.71, 28.96, 27.93, 24.89.

Polyester-polyol/Poly5: 1H NMR (500 MHz, Chloroform-d) δ=4.21 (s), 4.15 (s), 4.11 (s), 4.08 (s), 4.07 (s), 3.62 (s), 2.57 (s), 2.34 (s), 2.24 (s), 1.91 (s), 1.81 (s), 1.55 (s), 1.25 (s).¹³C NMR (126 MHz, Chloroform-d) δ=174.25, 172.27, 76.97, 61.41, 60.80, 59.13, 34.20, 31.69, 28.93, 27.91, 24.87.

Polyester-polyol/Poly6: ¹H NMR (500 MHz, Chloroform-d) δ=4.00 (s), 3.53 (s), 2.49 (s), 2.15 (s), 1.83 (s), 1.47 (s), 1.17 (s). ¹³C NMR (126 MHz, Chloroform-d) δ=173.63, 172.15, 77.36, 60.80, 60.71, 58.68, 34.16, 31.72, 28.83, 27.95, 24.78.

Initially, 25% of succinic acid were replaced with sebacic acid to form polyester-polyol Poly1, which exhibited a slightly lower viscosity of 2073 cP (Table 3, Run 02) compared with PPS. The difference in viscosities between the two polyols may be a result of the scale of preparation, and how well the two diacids were dispersed in polyol mixture during the polymerization. Furthermore, the substitution of succinic acid with 75% sebacic acid further reduced the viscosity by 1556 cP (Table 3, Run 04, Poly3). Interestingly, the replacement of 50% of succinic acid with sebacic acid showed a significant decrease in viscosity by 1355 cP (Table 3, Run 03, Poly2). The decrease in viscosity for Poly2 can be explained by the reduction in intermolecular forces due to fewer hydrogen bonds per molecule of polyol, whereas the 25:75 or 75:25 diacid combination delivered comparatively high viscosity polyester-polyols.

A similar trend was observed for succinic acid and azelaic acid-based polyester-polyols, where overall viscosity values for succinic-azelaic acid based polyester-polyol were lower compared to succinic-sebacic acid based polyester-polyol (Table 3, Runs 05-07, Poly4-Poly6). The 46% algae content polyester-polyol (prepared from 50% succinic acid and 50% azelaic acid, Table 2, Run 06) was found to be a least viscous: 887 cP (see Table 3, Run 06, Poly5).

A long chain, high algae-content (76%) azelaic acid- and 1,3-propanediol-based polyester-polyol Poly7 was prepared for viscosity comparison and resulted in lower viscosity material (1188 cP, Table 3, Run 08).

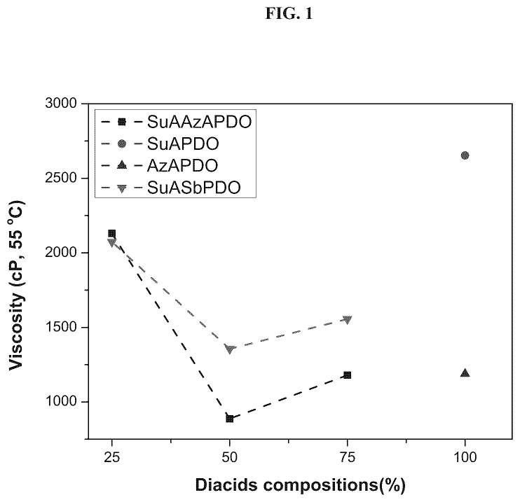

Varying the composition of two diacids resulted in liquid, solid, or semisolid polyester-polyols. Longer chain diacids provided a crystallizing phase between the polyols' “alkyl group”, whereas the liquid nature of Poly1 and Poly4 was likely due to interruption of hydrogen bonding due to the addition of 25% of sebacic or azelaic acid (Table 3, Run 02 and Run 05 respectively). FIG. 1 depicts the viscosity comparison between succinic/sebacic acid-based polyol, succinic/azelaic acid-based polyol, succinic acid-based polyol, and azelaic acid-based polyol.

TABLE 2
Diacids composition and algae content in polyester-polyol.

| | | Diacids ratio in polyols (in %) | | | |
|---|---|---|---|---|---|
| | | Succinic | Sebacic | Azelaic | Algae-carbon |
| Run | Polyols | acid | acid | acid | content (%) |
| 01 | PPS | 100 | — | — | — |
| 02 | Poly1 | 75 | 25 | — | — |
| 03 | Poly2 | 50 | 50 | — | — |
| 04 | Poly3 | 25 | 75 | — | — |
| 05 | Poly4 | 75 | — | 25 | 26.3 |
| 06 | Poly5 | 50 | — | 50 | 45.7 |
| 07 | Poly6 | 25 | — | 75 | 61.0 |
| 08 | Poly7 | — | — | 100 | 72.8 |

TABLE 3
Properties of polyester-polyols.

| | | | | Molecular | | |
|---|---|---|---|---|---|---|
| | | Acid value | OH number | weight (by | ªM_{w} | Viscosity |
| Run | Polyols | (mg of KOH g⁻¹) | (mg of KOH g⁻¹) | OH number) | (g/mol)/PDI | (55° C., cP) |
| 01 | PPS^{b} | 0.10 | 63 | 1800 | ND | 2653 |
| 02 | Poly1^{d} | 0.9 | 55 | 2000 | 22000/1.44 | 2073 |
| 03 | Poly2^{c} | 2.2 | 59 | 1900 | 19000/1.38 | 1355 |
| 04 | Poly3^{b} | 0.30 | 56 | 2000 | 20000/1.38 | 1556 |
| 05 | Poly4^{d} | 0.9 | 55 | 2000 | 22000/1.38 | 2130 |
| 06 | Poly5^{c} | 0.4 | 57 | 2000 | 14000/1.43 | 887 |
| 07 | Poly6^{b} | 2.0 | 56 | 2000 | 19000/1.45 | 1179 |
| 08 | Poly7^{b} | 1.4 | 56 | 2000 | ND | 1188 |

ªGPC molecular weight using polystyrene standard in DMF at 40° C.
^{b}Is a solid at 25° C.
^{c}Is a semisolid at 25° C.
^{d}Is a liquid at 25° C.
ND = Not determined.

The chain length of diacids plays a role in the viscosity of the polyester-polyols. The polyester-polyols prepared from longer diacids resulted in a lower viscosity compared to polyester-polyols prepared from shorter diacids. PPS, which has a shorter chain length C4 diacid (succinic acid), displayed a higher viscosity than the other polyester-polyols in Table 3. In another example, Poly7, was prepared from a longer chain length C9 diacid (azelaic acid) and revealed comparatively lower viscosity polyol in presence of the same diol (1,3-propanediol).

### Examples 2. Synthesis and Thermal Properties for Thermoplastic Polyurethanes (TPU1-8)

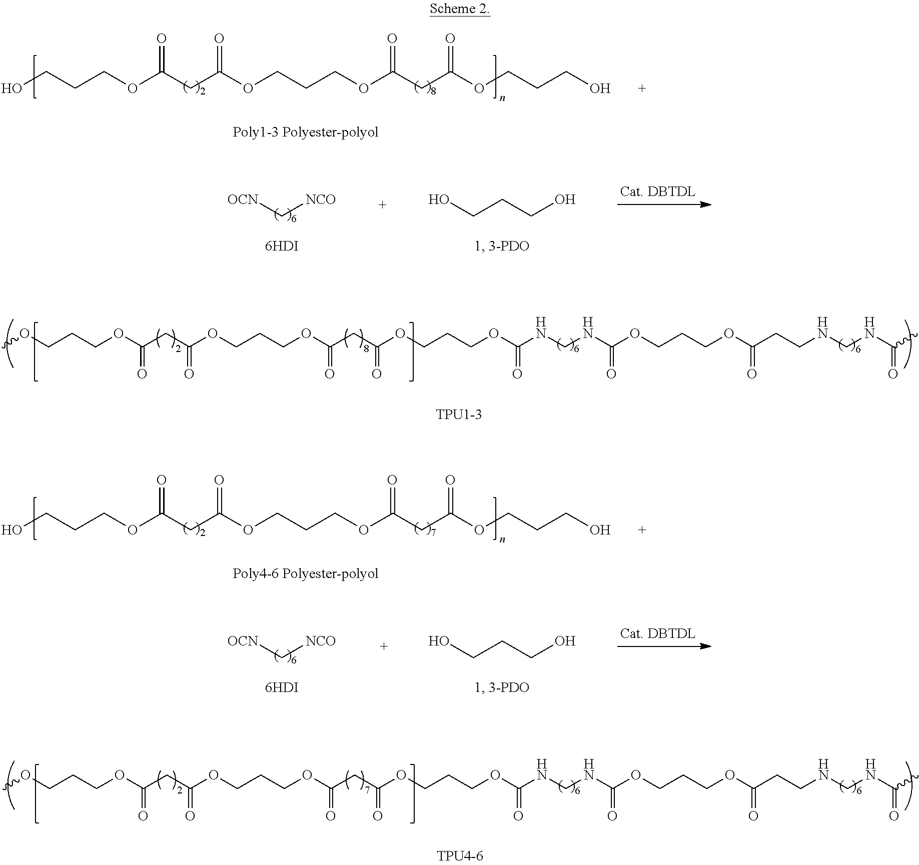

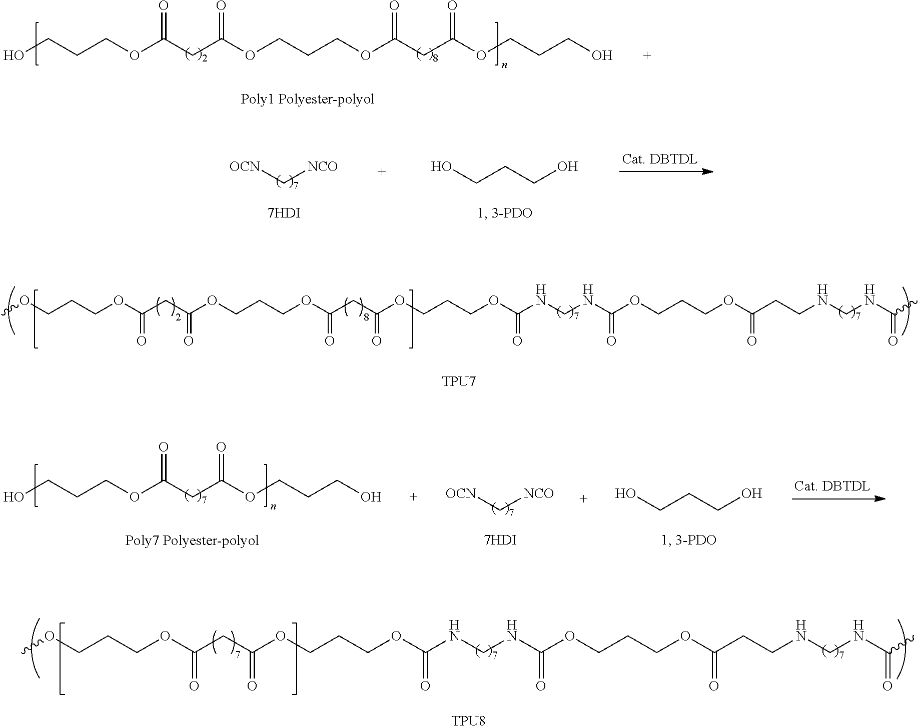

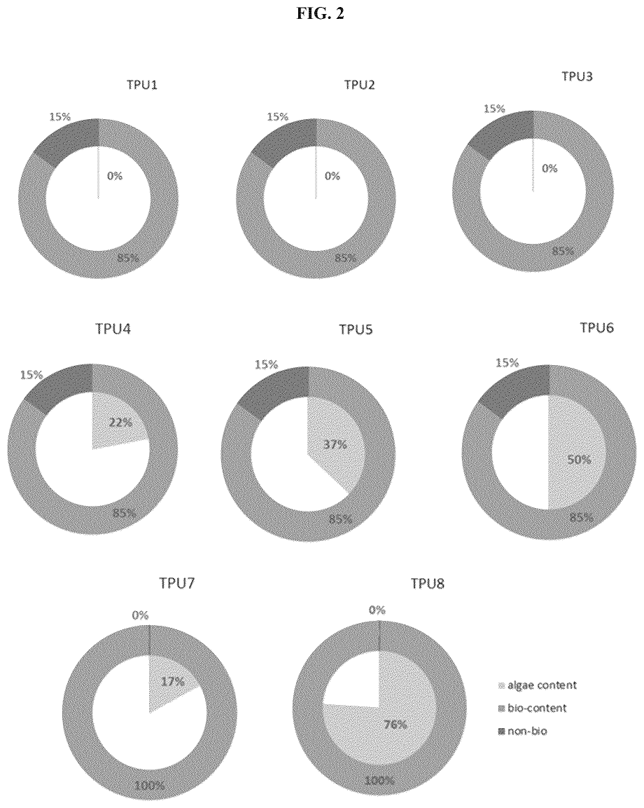

Polyester-polyols Poly1-Poly8 were subjected to TPU synthesis as described in the general procedure above. Prior to use, the polyester-polyols were de-moisturized in a vacuum oven for 24 hours at 70° C. Thermoplastic polyurethanes (TPU1-TPU6) were synthesized using a one-shot method with a 1.1 isocyanate index, by mixing polyester-polyols with a chain extender (e.g., 1,3-propanediol) and a catalyst (e.g., dibutyltin dilaurate (DBTDL)) and then reacting with 1,6-hexamethylene diisocyanate at a polyol/chain extender/diisocyanate ratio of 1/1/2.1 (See Table 4 for detailed formulations). The preparation of TPUs was attempted at temperatures as low as 75° C. Apart from using a petroleum-derived diisocyanate such as 6HDI for thermoplastic polyurethane applications, 1,7-heptamethylene diisocyanate (7HDI) was also used. 7HDI was prepared from algae-based azelaic acid using a previously reported flow-chemistry method.²⁴ Thermoplastic polyurethane synthesis of TPU7 and TPU8 using 7HDI was carried out using a similar method as above-described for 6HDI-based TPUs (Scheme 2). The synthesized TPUs contain up to 76% of algae content and up to 100% bio-content (see Table 5 for more details). FIG. 2 provides a visual representation of algae-content and bio-content in these TPUs.

Preliminarily, the completion of polyurethane reaction for TPUs was confirmed by FTIR spectroscopy: the complete disappearance of the isocyanate peak at around 2250-2285 cm⁻¹ was observed. The IR absorption peak at 3300 cm⁻¹ corresponds to the —NH stretching frequency and the peak at around 1750 cm⁻¹ is assigned to carbonyl carbon (—C═O). Furthermore, the identity of polyurethane structure is established by NMR spectroscopy. The ¹H NMR of TPU1 and TPU4 show the resonance at 7.01-7.02 ppm corresponds to the urethane —NH proton, indicating the formation of polyurethane. In ¹³C NMR, the chemical shift at around 157 ppm originates from the urethane linkage (—NHCOO), further confirming the formation of TPU1 and TPU4.

TPU1: ¹H NMR (500 MHz, DMSO-d₆) δ=7.01 (s), 4.00 (s), 3.92 (s), 3.31 (s), 2.88 (s), 2.50 (s), 2.21 (s), 1.83 (s), 1.45 (s), 1.31 (s), 1.18 (s). ¹³C NMR (126 MHz, DMSO-d₆) δ=173.69, 172.70, 156.93, 61.32, 40.62, 39.94, 39.77, 34.20, 29.36, 29.18, 28.28, 25.20.

TPU4: ¹H NMR (500 MHz, DMSO-d₆) δ=7.02 (s), 3.98 (s), 3.92 (s), 3.33 (s), 2.87 (s), 2.50 (s), 2.22 (s), 1.80 (s), 1.44 (s), 1.31 (s), 1.19 (s). ¹³C NMR (126 MHz, DMSO-d₆) δ=174.06, 173.07, 157.29, 62.07, 41.13, 40.96, 40.45, 40.11, 34.53, 30.53, 29.71, 29.49, 29.43, 29.20, 28.63, 27.11, 25.52.

Thermal properties of the TPU1, TPU4 and TPU7 were determined by differential scanning colorimetry (DSC) and thermal gravimetric analysis (TGA). DSC analysis of TPUs was performed in the temperature range of −120 to 220° C. at a heating rate of 10° C. min⁻¹ (Table 4). The data for T_{g} and Tₘ was recorded from the scan of the second heating run. TPUs shows the glass transition temperature (T_{g}) around −44.8 to −39.7° C. and melting temperatures (Tₘ) up to 98.3-105.9° C. The lower T_{g} value indicates that the TPUs possess a soft block structure.

TABLE 4
Designations, chemical composition, molar ratio of
monomers, and catalyst used in preparation of TPUs.

| | | Molar ratio |
|---|---|---|
| TPUs | Chemical composition | Polyol:PDO:Isocyanate |
| TPU1 | Poly1, 6HDI, PDO | 1:1:2.1 |
| TPU2 | Poly2, 6HDI, PDO | 1:1:2.1 |
| TPU3 | Poly3, 6HDI, PDO | 1:1:2.1 |
| TPU4 | Poly4, 6HDI, PDO | 1:1:2.1 |
| TPU5 | Poly5, 6HDI, PDO | 1:1:2.1 |
| TPU6 | Poly6, 6HDI, PDO | 1:1:2.1 |
| TPU7 | Poly1, 7HDI, PDO | 1:1:2.1 |
| TPU8 | Poly7, 7HDI, PDO | 1:1:2.1 |

Catalyst DBTDL = 0.032 wt. % for each of TPU1-TPU8.

The mechanical properties for TPUs were determined using the ASTM D638 standard. The TPUs show excellent mechanical properties at room temperature (tensile strength in between 14-42 MPa and an elongation break in between 350-1020 (Table 5). The TPUs synthesized from 1,7-heptamethylene diisocyanate (7HDI) show lower tensile strength: 14 MPa and 17 MPa for TPU7 and TPU8, respectively. The lower tensile strength could be due to the odd number of carbons in the isocyanate (7HDI) used during TPU synthesis. The difference in TPUs properties is also related to differences in phase separation between hard and soft segments as a result of formation of hydrogen bonds as well as dipole-dipole interactions.²⁵

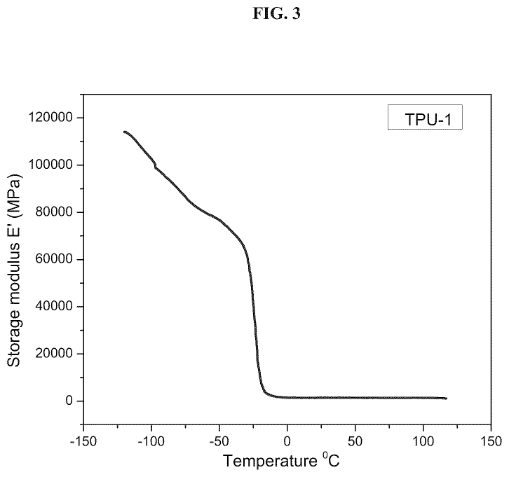

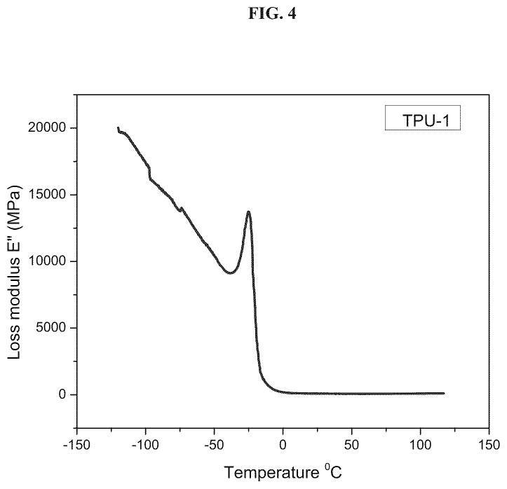

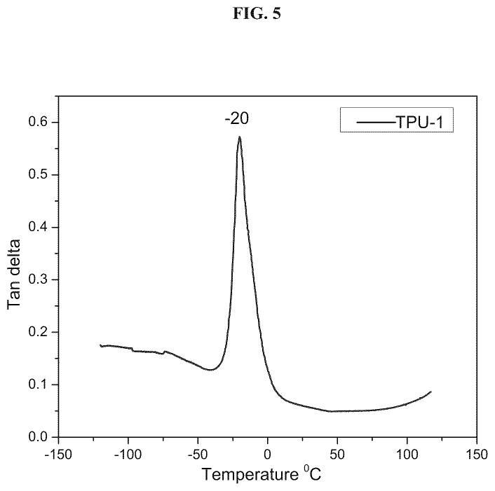

The stability of TPUs were determined from TGA analysis, and TPUs were found to be stable up to 300° C. Dynamic mechanical analysis (DMA) of TPU1 shows a much more gradual decrease in storage and loss modulus (FIG. 3 and FIG. 4). This may be due to the presence of higher physical crosslinking making the material stronger. The glass transition temperature value from tan delta for TPU1 was identified around −20° C. (FIG. 5).

TABLE 5
Properties for thermoplastic polyurethanes.

| Properties | TPU1 | TPU2 | TPU3 | TPU4 | TPU5 | TPU6 | TPU7 | TPU8 |
|---|---|---|---|---|---|---|---|---|
| GPC Mₙ (g/mol) | 189 × 10³ | 133 × 10³ | ND | 312 × 10³ | ND | ND | 209 × 10³ | ND |
| GPC M_{w} (g/mol) | 395 × 10³ | 200 × 10³ | ND | 739 × 10³ | ND | ND | 606 × 10³ | ND |
| GPC M_{w}/Mₙ | 2.01 | 1.50 | ND | 2.37 | ND | ND | 2.89 | ND |
| Hard segment | 18 | 19 | 18 | 18 | 18 | 18 | 19 | 19 |
| concentration, % | | | | | | | | |
| Tensile strength at | 39 | 18 | 41 | 42 | 29 | 29 | 14 | 17 |
| RT, MPa | | | | | | | | |
| Elongation at break | 925 | 508 | 806 | 1020 | 773 | 783 | 760 | 350 |
| at RT, % | | | | | | | | |
| Shore A hardness | 85 | 88 | 85 | 85 | 88 | 87 | 70 | 88 |
| @ RT | | | | | | | | |
| Tan Delta | −20.0 | ND | ND | ND | ND | ND | ND | ND |
| (DMA, ° C.) | | | | | | | | |
| Thermal transitions | T_{g} = −39.7 | ND | ND | T_{g} = −44.8 | ND | ND | T_{g} = −41.3 | ND |
| (DSC, ° C.) | Tₘ = 98.3 | | | Tₘ = 101.2 | | | Tₘ = 105.9 | |
| Algae-carbon | 0 | 0 | 0 | 22 | 37 | 50 | 17 | 76 |
| content (%) | | | | | | | | |
| Bio-carbon | 85 | 85 | 85 | 85 | 85 | 85 | 100 | 100 |
| content (%) | | | | | | | | |

### Biodegradation of TPUs

For biodegradation studies, TPU1 and TPU4 were subjected to compost biodegradation in controlled environments as described in the general procedure above. Biodegradation of polymers occurred through a combination of steps: (a) the surface of the polymer was colonized by the surrounding microorganisms (i.e., compost microorganisms) often leading to physical fracturing of the surface; (b) these microorganisms then secrete relevant hydrolase enzymes, which catalyze the hydrolysis of susceptible bonds within the polymer leading to lower molecular weight products in what is known as depolymerization; and (c) the lower molecular weight products were incorporated by the microorganisms into cell biomass, as well as released as inorganic products.²⁶ Under home-compost conditions at 45° C. with 75-85% relative humidity, significant decreases in molecular weight of these polyester-polyol TPUs was observed compared to a polyether-TPU that was not expected to biodegrade due to the presence of ether bonds, which are recalcitrant to biodegradation processes.³ The findings indicate that TPUs of the present technology are susceptible to biodegradation under compost conditions.

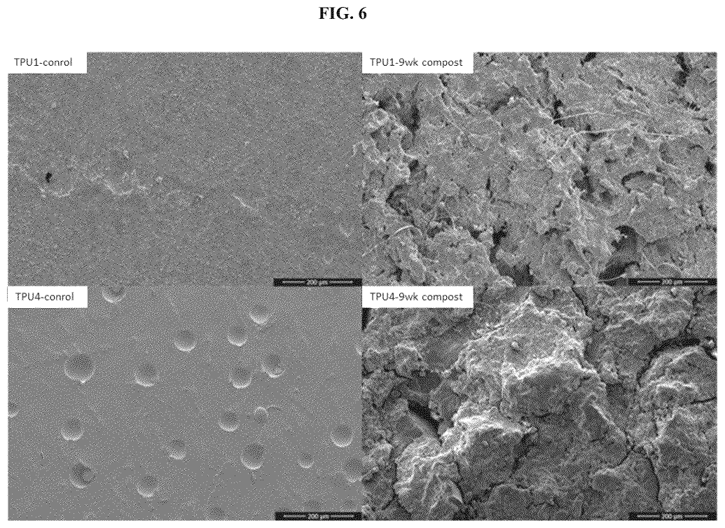

SEM results showed the change in surface morphology for degraded TPU1 and TPU4 after nine weeks compared to control sample, suggesting occurrence of the first step in the biodegradation process—surface colonization and physical fracturing (FIG. 6).

Gel Permeation Chromatography (GPC) was used to analyze the change in molecular weight (Table 6) throughout the biodegradation process, specifically the depolymerization step. After nine weeks, TPU1 showed approximately 32.3% (Mₙ) and 32.7% (M_{w}) decrease in molecular weight by GPC compared to its initial molecular weight prior to compost incubation. A similar trend was observed for TPU4 for nine weeks under compost conditions, showing decreased in molecular weight of 53.6% (Mₙ) and 57.5% (M_{w}) respectively. A commercial petroleum-based, polyether-TPU (BASF Elastollan®) was used as a negative control-TPU. This negative control had approximately 11.7% (Mₙ) and 1.7% (M_{w}) decrease in molecular weight, which could be attributed to some breakdown of urethane linkages.

TABLE 6
Compost biodegradation for TPU1 and TPU4 using GPC analysis.*

| | | | | | Compost/ | |
|---|---|---|---|---|---|---|
| | | | | | Control | |
| | | | | | % loss | |
| | Control | | Compost (9 wk) | | % Mₙ | % M_{w} |
| Sample | Mₙ | M_{w} | Mₙ | M_{w} | loss | loss |
| TPU1 | 166,587 ± | 334,090 ± | 112,746 ± | 224,897 ± | 32.3 | 32.7 |
| | 19,428.5 | 47,835.3 | 10,167.9 | 3,713.53 | | |
| TPU4 | 59,615 ± | 94,873 ± | 27,636 ± | 40,364 ± | 53.6 | 57.5 |
| | 10,697 | 5,529.8 | 155.87 | 1,321.9 | | |
| Polyether- | 179,122 ± | 285,488 ± | 158,091 ± | 280,620 ± | 11.7 | 1.7 |
| TPU | 6,665.41 | 95,092.0 | 18,123.2 | 4,530.7 | | |
| (negative | | | | | | |
| control) | | | | | | |

*Average Mₙ and M_{w} values are presented with standard deviations of triplicate samples. A commercial polyether-TPU was used as a negative control for a TPU that is non-biodegrading due to the ether bonds present. Compost/Control % loss = 100%-[Compost]/[Control].

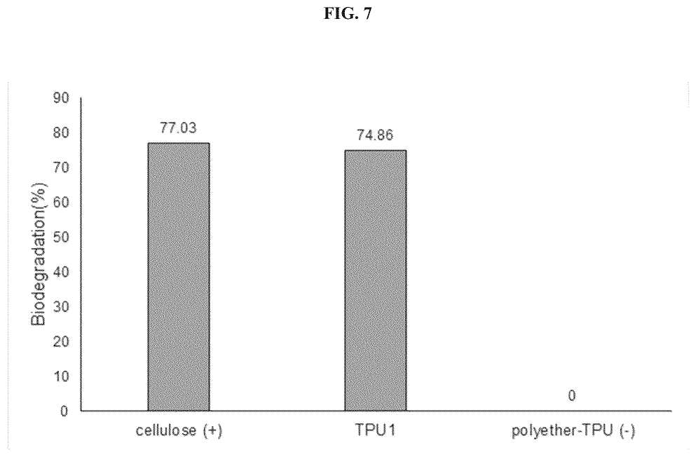

Additionally, respirometry analysis of TPU1 was conducted following ASTM D5338, which utilizes carbon dioxide production as a metric for biodegradation (FIG. 7). Increased production of carbon dioxide compared to compost by itself or a negative control indicates that the polymer is being depolymerized and mineralized by compost microorganisms. Carbon content of samples is used to determine the biodegradation percentage of samples. This test was conducted for approximately 15 weeks and it was found that TPU1 achieved 74.86% biodegradation, while the polyether-TPU (negative control) did not appear to biodegrade, with carbon dioxide production below baseline levels from compost. This is most likely due to background variation in carbon dioxide produced within each compost vessel.

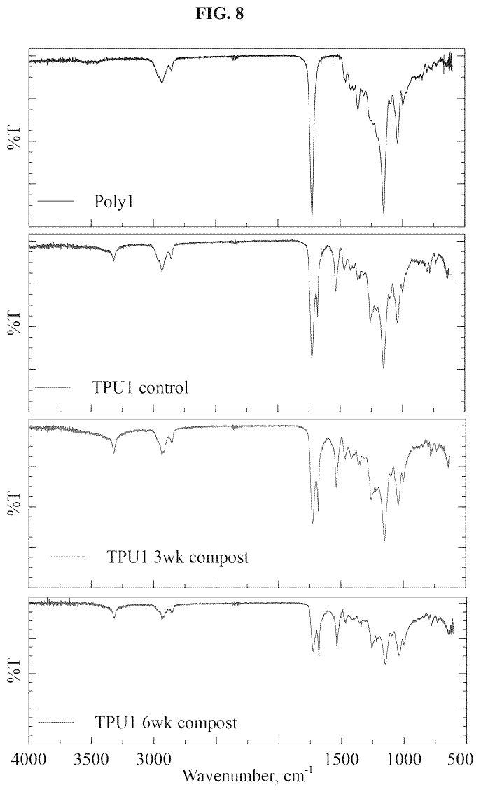

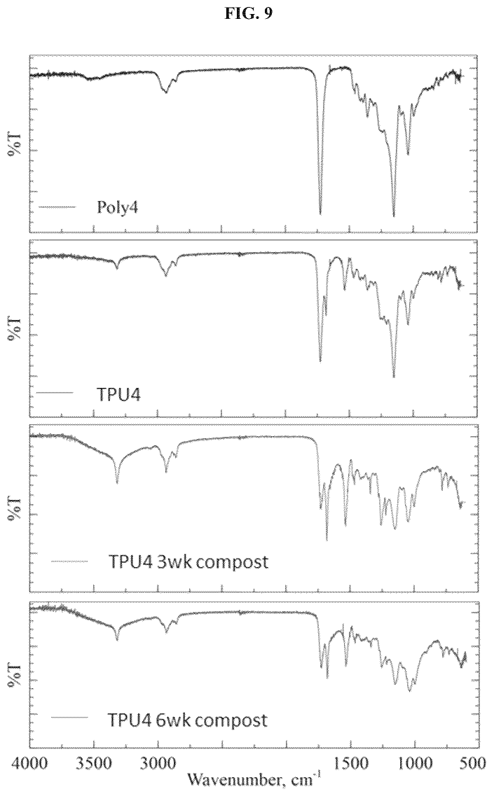

FTIR of the TPUs were taken after 3- and 6-weeks incubation in compost and compared to the polyol and control TPU (FIG. 8 and FIG. 9). The peak at 1750 cm⁻¹ was present in both the polyol and TPUs spectra and was identified as polyester carbonyl stretching. The peak at 1600 cm⁻¹, present in only the TPU, was identified as the urethane carbonyl stretching. Over the incubation time, the ratio of the urethane to the ester carbonyl peaks increased, indicating preferential hydrolysis of the polyester carbonyl. The peak height of the —NH stretching at 3300 cm⁻¹ also indicated that the concentration of amines in the TPUs was increasing because of the urethane group hydrolysis and removal from the polymer chain. The clear indication of peak height difference was observed in TPU4 compared to the TPU1.

### Certain Embodiments

Embodiment 1. A method to prepare a biodegradable thermoplastic polyurethane (TPU), the method comprising:
contacting succinic acid, a linear aliphatic dicarboxylic acid with at least 9 carbons, and a C₂-C₆ diol in a first polymerization reaction to obtain a linear aliphatic polyester-polyol; and
contacting the linear aliphatic polyester-polyol with a chain extender and a diisocyanate in a second polymerization reaction to obtain the TPU;
wherein the linear aliphatic polyester-polyol has a viscosity of less than 2400 cP at 55° C.

Embodiment 2. The method of Embodiment 1, wherein the linear aliphatic polyester-polyol has a viscosity of about 887 cP to about 2130 cP at 55° C.

Embodiment 3. The method of Embodiment 1 or Embodiment 2, wherein the linear aliphatic dicarboxylic acid comprises azelaic acid, sebacic acid, undecanedioic acid, dodecanedioic acid, tridecanedioic acid, or a combination of two or more thereof.

Embodiment 4. The method of any one of Embodiments 1-3, wherein the linear aliphatic dicarboxylic acid is derived from algae.

Embodiment 5. The method of any one of Embodiments 1-4, wherein succinic acid and the linear aliphatic dicarboxylic acid are present in the first polymerization reaction in a molar ratio of greater than 1:1.

Embodiment 6. The method of any one of Embodiments 1-5, wherein succinic acid and the linear aliphatic dicarboxylic acid are present in the first polymerization reaction in a molar ratio of at least 3:1.

Embodiment 7. The method of any one of Embodiments 1-6, wherein the C₂-C₆ diol comprises 1,3-propanediol; 1,4-butanediol; 1,5-pentanediol; 1,6-hexanediol; or a combination of two or more thereof.

Embodiment 8. The method of any one of Embodiments 1-7, wherein the first polymerization reaction is initially conducted at a temperature of about 150° C. to about 160° C.

Embodiment 9. The method of Embodiment 8, wherein the temperature for the first polymerization reaction is subsequently raised to about 180° C. for at least 2 days.

Embodiment 10. The method of any one of Embodiments 1-9, wherein the linear aliphatic polyester-polyol is a liquid at 25° C.

Embodiment 11. The method of any one of Embodiments 1-9, wherein the linear aliphatic polyester-polyol has a molecular weight (by OH number value or hydroxyl number value) of about 1800 to about 2000.

Embodiment 12. The method of any one of Embodiments 1-11, wherein the chain extender comprises 1,3-propanediol; 1,4-butanediol; 1,5-pentanediol; 1,6-hexanediol; or a combination of two or more thereof.

Embodiment 13. The method of any one of Embodiments 1-12, wherein the diisocyanate comprises 1,6-hexamethylene diisocyanate, 1,7-heptamethylene diisocyanate, or a combination thereof.

Embodiment 14. The method of any one of Embodiments 1-13, wherein the diisocyanate is derived from algae.

Embodiment 15. The method of any one of Embodiments 1-14, wherein the polyester-polyol, the chain extender, and the diisocyanate are present in the TPU in a molar ratio of 1:1:2.1 to 1:1:2.2 (polyester-polyol:chain extender:diisocyanate).

Embodiment 16. The method of any one of Embodiments 1-15, wherein the second polymerization reaction is conducted at about 75° C.

Embodiment 17. The method of any one of Embodiments 1-16, wherein the second polymerization reaction further comprises a catalyst.

Embodiment 18. The method of Embodiment 17, wherein the catalyst is dibutyltin dilaurate.

Embodiment 19. The method of any one of Embodiments 1-18, wherein the TPU has a number average molecular weight (Mₙ) of about 133,000 to about 312,000 g/mol.

Embodiment 20. The method of any one of Embodiments 1-19, wherein the TPU has about 17% to about 76% carbon content from algae.

Embodiment 21. The method of any one of Embodiments 1-20, wherein the TPU demonstrates at least about 30% decrease in number average molecular weight (Mₙ) or weight average molecular weight (M_{w}) after incubation under composting conditions for 9 weeks.

Embodiment 22. The method of Embodiment 21, wherein the composting conditions comprise contact with one or more compost microorganisms at a temperature of about 45° C. with about 75% to 85% relative humidity.

Embodiment 23. The method of any one of Embodiments 1-22, wherein the TPU achieves at least 70% biodegradation as measured by respirometry analysis after ASTM D5338 testing.

Embodiment 24. A linear aliphatic polyester-polyol comprising subunits from succinic acid, a linear aliphatic dicarboxylic acid with at least 9 carbons, and a C₂-C₆ diol, wherein the polyester-polyol has a viscosity of less than 2400 cP at 55° C.

Embodiment 25. The polyester-polyol of Embodiment 24 which is a liquid at 25° C.

Embodiment 26. The polyester-polyol of Embodiment 24 or Embodiment 25, wherein the polyester-polyol has a viscosity of about 887 cP to about 2130 cP at 55° C.

Embodiment 27. The polyester-polyol of any one of Embodiments 24-26, wherein the linear aliphatic dicarboxylic acid comprises azelaic acid, sebacic acid, undecanedioic acid, dodecanedioic acid, tridecanedioic acid, or a combination of two or more thereof.

Embodiment 28. The polyester-polyol of any one of Embodiment 24-27, wherein the linear aliphatic dicarboxylic acid with at least 9 carbons is derived from algae.

Embodiment 29. The polyester-polyol of any one of Embodiments 24-28, wherein more than 50% of dicarboxylic acid subunits are from succinic acid.

Embodiment 30. The polyester-polyol of any one of Embodiments 24-29, wherein at least 75% of dicarboxylic acid subunits are from succinic acid.

Embodiment 31. The polyester-polyol of any one of Embodiments 24-30, wherein the C₂-C₆ diol comprises 1,3-propanediol; 1,4-butanediol; 1,5-pentanediol; 1,6-hexanediol; or a combination of two or more thereof.

Embodiment 32. The polyester-polyol of any one of Embodiments 24-31, wherein the polyester-polyol has a molecular weight (by OH number value or hydroxyl number value) of about 1800 to about 2000.

Embodiment 33. A biodegradable thermoplastic polyurethane (TPU) comprising subunits from a diisocyanate, a chain extender, and a linear aliphatic polyester-polyol, wherein the polyester-polyol has a viscosity of less than 2400 cP at 55° C.; and wherein the TPU demonstrates at least about 30% decrease in number average molecular weight (Mₙ) or weight average molecular weight (M_{w}) after incubation under composting conditions for 9 weeks.

Embodiment 34. The biodegradable TPU of Embodiment 33, wherein the composting conditions comprise contact with one or more compost microorganisms at a temperature of about 45° C. with about 75% to 85% relative humidity.

Embodiment 35. The biodegradable TPU of Embodiment 33 or Embodiment 34, wherein the diisocyanate comprises 1,6-hexamethylene diisocyanate, 1,7-heptamethylene diisocyanate, or a combination thereof.

Embodiment 36. The biodegradable TPU of any one of Embodiments 33-35, wherein the diisocyanate is derived from algae.

Embodiment 37. The biodegradable TPU of any one of Embodiments 33-36, wherein the chain extender comprises 1,3-propanediol; 1,4-butanediol; 1,5-pentanediol; 1,6-hexanediol; or a combination of two or more thereof.

Embodiment 38. The biodegradable TPU of any one of Embodiments 33-37, wherein the polyester-polyol comprises subunits from succinic acid, a linear aliphatic dicarboxylic acid with at least 9 carbons, and a C₂-C₆ diol.

Embodiment 39. The biodegradable TPU of Embodiment 38, wherein the linear aliphatic dicarboxylic acid comprises azelaic acid, sebacic acid, undecanedioic acid, dodecanedioic acid, tridecanedioic acid, or a combination of two or more thereof.

Embodiment 40. The biodegradable TPU of Embodiment 38 or Embodiment 39, wherein the linear aliphatic dicarboxylic acid is derived from algae.

Embodiment 41. The biodegradable TPU of any one of Embodiments 38-40, wherein more than 50% of dicarboxylic acid subunits in the polyester-polyol are from succinic acid.

Embodiment 42. The biodegradable TPU of any one of Embodiments 38-40, wherein at least 75% of dicarboxylic acid subunits in the polyester-polyol are from succinic acid.

Embodiment 43. The biodegradable TPU of any one of Embodiments 38-42, wherein the C₂-C₆ diol comprises 1,3-propanediol; 1,4-butanediol; 1,5-pentanediol; 1,6-hexanediol; or a combination of two or more thereof.

Embodiment 44. The biodegradable TPU of any one of Embodiments 38-43 wherein the polyester-polyol, the chain extender, and the diisocyanate are present in the TPU in a molar ratio of 1:1:2.1 to 1:1:2.2 for polyester-polyol:chain extender:diisocyanate.

Embodiment 45. The biodegradable TPU of any one of Embodiments 33-44, wherein the polyester-polyol is a liquid at 25° C.

Embodiment 46. The biodegradable TPU of any one of Embodiments 33-45, wherein the polyester-polyol has a viscosity of about 887 cP to about 2130 cP at 55° C.

Embodiment 47. The biodegradable TPU of any one of Embodiments 33-46, wherein the TPU has a number average molecular weight (Mₙ) of about 133,000 to about 312,000 g/mol.

Embodiment 48. The biodegradable TPU of any one of Embodiments 33-47, wherein the TPU has about 17% to about 76% carbon content from algae.

Embodiment 49. The biodegradable TPU of any one of Embodiments 33-48, wherein the TPU achieves at least 70% biodegradation as measured by respirometry analysis after ASTM D5338 testing.

Embodiment 50. A process to prepare paint, the process comprising:
preparing a polyester polyol of 1000 to 3000 g/mol molecular weight from succinic acid, a linear aliphatic dicarboxylic acid with at least 9 carbons, and a C₂-C₆ diol; wherein the linear aliphatic dicarboxylic acid is derived from algae;
preparing a TPU from (a) the polyester polyol; (b) a chain extender; (c) a tin- or titanium-based catalyst; and (d) an aromatic or aliphatic diisocyanate; wherein the TPU comprises 65 wt. % to 90 wt. % polyester polyol, 2 wt. % to 6 wt. % chain extender; and 10% to 30% hard segment due to the diisocyanate; and
solubilizing the TPU in a solvent to provide a TPU solution; and
mixing the TPU solution with a pigment to produce the paint.

Embodiment 51. The process of Embodiment 50, wherein the TPU was prepared from a polyester polyol of 1500 g/mol molecular weight, propanediol at 6 parts per 100 parts of polyol, a tin- or titanium-based catalyst, and 1,6-hexamethylene diisocyanate (6HDI) or 1,7-heptamethylene diisocyanate (7HDI) with about 23% hard segment.

Embodiment 52. The process of Embodiment 50 or Embodiment 51, wherein the paint comprises 2 wt. % to 40 wt. % TPU, 0 wt. % to 10 wt. % pigment, 60 wt. % to 98 wt. % N,N′-dimethylformamide, and 0 wt. % to 20 wt. % methyl ethyl ketone.

Embodiment 53. The process of any one of Embodiments 50-52, wherein the paint comprises about 10 wt. % TPU, 2 wt. % pigment, and 88 wt. % N,N′-dimethylformamide.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, or compositions, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

### REFERENCES

1. Bennett, S. J.; Page, H. A., Implications of Climate Change for the Petrochemical Industry: Mitigation Measures and Feedstock Transitions. In Handbook of Climate Change Mitigation and Adaptation, Chen, W.-Y.; Suzuki, T.; Lackner, M., Eds. Springer International Publishing: Cham, 2017; pp 383-426.
2. Pellis, A.; Malinconico, M.; Guarneri, A.; Gardossi, L., Renewable polymers and plastics: Performance beyond the green. New Biotechnology 2021, 60, 146-158.
3. Howard, G. T., Biodegradation of polyurethane: a review. International Biodeterioration & Biodegradation 2002, 49 (4), 245-252.
4. Datta, J.; Kasprzyk, P., Thermoplastic polyurethanes derived from petrochemical or renewable resources: A comprehensive review. Polymer Engineering & Science 2018, 58 (S1), E14-E35.
5. Orgilés-Calpena, E.; Arán-Aís, F.; Torró-Palau, A.; Orgilés-Barceló, C., Biodegradable polyurethane adhesives based on polyols derived from renewable resources. Proceedings of the Institution of Mechanical Engineers, Part L: Journal of Materials: Design and Applications 2014, 228 (2), 125-136.
6. Mecking, S., Nature or petrochemistry?-biologically degradable materials. Angewandte Chemie (International ed. in English) 2004, 43 (9), 1078-85.
7. Zhu, Y.; Romain, C.; Williams, C. K., Sustainable polymers from renewable resources. Nature 2016, 540 (7633), 354-362.
8. Phung Hai, T. A.; Neelakantan, N.; Tessman, M.; Sherman, S. D.; Griffin, G.; Pomeroy, R.; Mayfield, S. P.; Burkart, M. D., Flexible polyurethanes, renewable fuels, and flavorings from a microalgae oil waste stream. Green Chemistry 2020, 22 (10), 3088-3094.
9. Rajput, B. S.; Gaikwad, S. R.; Menon, S. K.; Chikkali, S. H., Sustainable polyacetals from isohexides. Green Chemistry 2014, 16 (8), 3810-3818.
10. Rajput, B. S.; Chander, U.; Arole, K.; Stempfle, F.; Menon, S.; Mecking, S.; Chikkali, S. H., Synthesis of Renewable Copolyacetals with Tunable Degradation. Macromolecular Chemistry and Physics 2016, 217 (12), 1396-1410.
11. Rajput, B. S.; Ram, F.; Menon, S. K.; Shanmuganathan, K.; Chikkali, S. H., Cross-metathesis of biorenewable dioxalates and diols to film-forming degradable polyoxalates. Journal of Polymer Science Part A: Polymer Chemistry 2018, 56 (14), 1584-1592.
12. Fagnani, D. E.; Tami, J. L.; Copley, G.; Clemons, M. N.; Getzler, Y. D. Y. L.; McNeil, A. J., 100th Anniversary of Macromolecular Science Viewpoint: Redefining Sustainable Polymers. ACS Macro Letters 2021, 10 (1), 41-53.
13. Phung Hai, T. A.; Tessman, M.; Neelakantan, N.; Samoylov, A. A.; Ito, Y.; Rajput, B. S.; Pourahmady, N.; Burkart, M. D., Renewable Polyurethanes from Sustainable Biological Precursors. Biomacromolecules 2021, 22 (5), 1770-1794.
14. Pandey, S.; Rajput, B. S.; Chikkali, S. H., Refining plant oils and sugars to platform chemicals, monomers, and polymers. Green Chemistry 2021, 23 (12), 4255-4295.
15. Furtwengler, P.; Avérous, L., Renewable polyols for advanced polyurethane foams from diverse biomass resources. Polymer Chemistry 2018, 9 (32), 4258-4287.
16. Palaskar, D. V.; Boyer, A.; Cloutet, E.; Alfos, C.; Cramail, H., Synthesis of Biobased Polyurethane from Oleic and Ricinoleic Acids as the Renewable Resources via the AB-Type Self-Condensation Approach. Biomacromolecules 2010, 11 (5), 1202-1211.
17. Argyropoulos, J.; Popa, P.; Spilman, G.; Bhattacharjee, D.; Koonce, W., Seed oil based polyester polyols for coatings. Journal of Coatings Technology and Research 2009, 6 (4), 501-508.
18. Parcheta, P.; Datta, J., Structure analysis and thermal degradation characteristics of bio-based poly(propylene succinate)s obtained by using different catalyst amounts. Journal of Thermal Analysis and Calorimetry 2017, 130 (1), 197-206.
19. Król, P., Synthesis methods, chemical structures and phase structures of linear polyurethanes. Properties and applications of linear polyurethanes in polyurethane elastomers, copolymers and ionomers. Progress in Materials Science 2007, 52 (6), 915-1015.
20. Kim, Y. D.; Kim, S. C., Effect of chemical structure on the biodegradation of polyurethanes under composting conditions. Polymer Degradation and Stability 1998, 62 (2), 343-352.
21. Advancing Adhesives: Bio-Based Succinic Acid Polyester Polyols. https://www.adhesivesmag.com/articles/93913-advancing-adhesives-bio-based-succinic-acid-polyester-polyols Jun. 1, 2015.
22. Bio-Based Polyester Polyols for Performance Polyurethane Elastomers. https://www.gantrade.com/blog/bio-based-polyester-polyols-for-performance-polyurethane-elastomers Jan. 16, 2020.
23. Parcheta, P.; Głowińska, E.; Datta, J., Effect of bio-based components on the chemical structure, thermal stability and mechanical properties of green thermoplastic polyurethane elastomers. European Polymer Journal 2020, 123, 109422.
24. Tuan Ismail, T. N. M.; Ibrahim, N. A.; Palam, K. D. P.; Sendijarevic, A.; Sendijarevic, I.; M. Schiffman, C.; Hoong, S. S.; Noor, M. A. M.; Yeong, S. K.; Idris, Z.; Malek, E. A.; Zainuddin, N.; Sendijarevic, V., Effect of Chain Length for Dicarboxylic Monomeric Units of Polyester Polyols on the Morphology, Thermal and Mechanical Properties of Thermoplastic Urethanes. Journal of the American Oil Chemists' Society 2020, 97 (7), 737-749.
25. Phung Hai, T. A.; De Backer, L. J. S.; Cosford, N. D. P.; Burkart, M. D., Preparation of Mono- and Diisocyanates in Flow from Renewable Carboxylic Acids. Organic Process Research & Development 2020, 24 (10), 2342-2346.
26. Zumstein, M. T.; Schintlmeister, A., Biodegradation of synthetic polymers in soils: Tracking carbon into CO(2) and microbial biomass. 2018, 4 (7), eaas9024.

What is claimed is:

1. A method to prepare a biodegradable thermoplastic polyurethane (TPU), the method comprising
contacting succinic acid, a linear aliphatic dicarboxylic acid with at least 9 carbons, and a C₂-C₆ diol in a first polymerization reaction to obtain a linear aliphatic polyester-polyol; and
contacting the linear aliphatic polyester-polyol with a chain extender and a diisocyanate in a second polymerization reaction to obtain the TPU;
wherein the linear aliphatic polyester-polyol has a viscosity of less than 2400 cP at 55° C.

2. The method of claim 1, wherein the linear aliphatic dicarboxylic acid comprises azelaic acid, sebacic acid, undecanedioic acid, dodecanedioic acid, tridecanedioic acid, or a combination of two or more thereof.

3. The method of claim 1, wherein the C₂-C₆ diol comprises 1,3-propanediol; 1,4-butanediol; 1,5-pentanediol; 1,6-hexanediol; or a combination of two or more thereof.

4. The method of claim 1, wherein the linear aliphatic polyester-polyol has a molecular weight (by OH number value or hydroxyl number value) of about 1800 to about 2000.

5. The method of claim 1, wherein the chain extender comprises 1,3-propanediol; 1,4-butanediol; 1,5-pentanediol; 1,6-hexanediol; or a combination of two or more thereof.

6. The method of claim 1, wherein the diisocyanate comprises 1,6-hexamethylene diisocyanate, 1,7-heptamethylene diisocyanate, or a combination thereof.

7. The method of claim 1, wherein the polyester-polyol, the chain extender, and the diisocyanate are present in the TPU in a molar ratio of 1:1:2.1 to 1:1:2.2 (polyester-polyol:chain extender:diisocyanate).

8. The method of claim 1, wherein the TPU has a number average molecular weight (Mₙ) of about 133,000 to about 312,000 g/mol.

9. The method of claim 1, wherein the TPU has about 17% to about 76% carbon content from algae.

10. The method of claim 1, wherein the TPU achieves at least 70% biodegradation as measured by respirometry analysis after ASTM D5338 testing.

11. A linear aliphatic polyester-polyol comprising subunits from succinic acid, a linear aliphatic dicarboxylic acid with at least 9 carbons, and a C₂-C₆ diol, wherein the polyester-polyol has a viscosity of less than 2400 cP at 55° C.

12. A biodegradable thermoplastic polyurethane (TPU) comprising subunits from a diisocyanate, a chain extender, and a linear aliphatic polyester-polyol, wherein the polyester-polyol has a viscosity of less than 2400 cP at 55° C.; and wherein the TPU demonstrates at least about 30% decrease in number average molecular weight (Mₙ) or weight average molecular weight (M_{w}) after incubation under composting conditions for 9 weeks.

13. The biodegradable TPU of claim 12, wherein the polyester-polyol comprises subunits from succinic acid, a linear aliphatic dicarboxylic acid with at least 9 carbons, and a C₂-C₆ diol.

14. The biodegradable TPU of claim 13, wherein at least 75% of dicarboxylic acid subunits in the polyester-polyol are from succinic acid.

15. The biodegradable TPU of claim 13, wherein the polyester-polyol, the chain extender, and the diisocyanate are present in the TPU in a molar ratio of 1:1:2.1 to 1:1:2.2 for polyester-polyol:chain extender:diisocyanate.

16. The biodegradable TPU of claim 12, wherein the polyester-polyol has a viscosity of about 887 cP to about 2130 cP at 55° C., and the TPU has a number average molecular weight (Mₙ) of about 133,000 to about 312,000 g/mol.

17. The biodegradable TPU of claim 12, wherein the TPU has about 17% to about 76% carbon content from algae.

18. A process to prepare paint, the process comprising:
preparing a polyester polyol of 1000 to 3000 g/mol molecular weight from succinic acid, a linear aliphatic dicarboxylic acid with at least 9 carbons, and a C2-C6 diol; wherein the linear aliphatic dicarboxylic acid is derived from algae;
preparing a TPU from (a) the polyester polyol; (b) a chain extender; (c) a tin- or titanium-based catalyst; and (d) an aromatic or aliphatic diisocyanate; wherein the TPU comprises 65 wt. % to 90 wt. % polyester polyol, 2 wt. % to 6 wt. % chain extender; and 10% to 30% hard segment due to the diisocyanate; and
solubilizing the TPU in a solvent to provide a TPU solution; and
mixing the TPU solution with a pigment to produce the paint.

19. The process of claim 18, wherein the TPU was prepared from a polyester polyol of 1500 g/mol molecular weight, propanediol at 6 parts per 100 parts of polyol, a tin- or titanium-based catalyst, and 1,6-hexamethylene diisocyanate (6HDI) or 1,7-heptamethylene diisocyanate (7HDI) with about 23% hard segment.

20. The process of claim 18, wherein the paint comprises 2 wt. % to 40 wt. % TPU, 0 wt. % to 10 wt. % pigment, 60 wt. % to 98 wt. % N,N′-dimethylformamide, and 0 wt. % to 20 wt. % methyl ethyl ketone.
